(19) United States
(12) Patent Application Publication
(10) Pub. No.: US 2006/0119692 A1
(43) Pub. Date: Jun. 8, 2006

(54) Order separation and multibeam formation-based printing apparatus using optical modulator

(76) Inventors: Haeng Seok Yang, Gyeonggi-do (KR); Dong Ho Shin, Seoul (KR); Kwan Young Oh, Gyeonggi-do (KR); Jun Won An, Gyeonggi-do (KR); Sang Kyeong Yun, Gyeonggi-do (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/189,550

(22) Filed: Jul. 25, 2005

(30) Foreign Application Priority Data
Dec. 2, 2004 (KR) 10-2004-0100577

(51) Int. Cl. B41J 2/385

(52) U.S. Cl. 347/134

(57) ABSTRACT

Disclosed herein is an order separation- and multibeam formation-based printing apparatus using an optical modulator, in which diffracted beams having two or more diffraction numbers, formed by reflecting and diffracting multibeam light, are assigned to respective photosensitive surface sections of a photosensitive drum according to wavelength and diffraction order to form latent images on the surface of the photosensitive drum at an improved resolution.

### BACKGROUND OF THE INVENTION

1. Field of the Invention

The present invention relates, in general, to a printing apparatus using an optical modulator and, more particularly, to an order separation- and multibeam formation-based printing apparatus using an optical modulator, in which diffracted beams formed from multibeam light through diffraction and reflection are radiated onto respective surface sections of a drum so as to form latent images having improved resolution on the surface of the drum.

2. Description of the Related Art

Nowadays, printer technology has been developing toward high speed, miniaturization, high resolution, and low cost. A typical laser printer employs a laser scanning scheme of scanning laser beams using a laser diode and an f-θ lens.

To achieve high-speed printing, an image head scheme taking advantage of a multibeam beamformer has been adopted. With such a scheme, high-speed and high-resolution printing is possible, but a high cost is also incurred because it requires a plurality of light sources.

With reference to FIG. 1, a conventional laser scanning scheme that uses a single light source and an f-θ lens is illustrated.

As seen in this figure, a conventional laser scanning operation starts with the emission of a light beam from a laser diode (LD) 10 in response to a video signal. The light beam is collimated by a collimator lens 11 into parallel light beams and is further converged on a polygon mirror 13 by a cylinder lens 12. While passing through the cylinder lens 12, the parallel light beams are converted into linear light beams that are parallel to a scanning direction.

Rotating at a constant speed, the polygon mirror 13 driven by a motor deflects the linear light beams incident thereon and scans them in the direction of an f-θ lens 15.

While the linear light beams are transmitted through the f-θ lens 15, their aberrations are corrected. The aberration-corrected linear light beams are reflected by a bend-back mirror 16 and scan a photosensitive drum 17 at a constant velocity due to the constant rotation speed of the polygon mirror 13.

Due to problems of a low switching speed of the laser diode 10 and a low scanning speed of the polygon mirror 13, this laser scanning scheme is difficult to apply to high printing speed implementation.

For example, an improvement in the scanning speed of the light beam in the laser scanning scheme requires the polygon mirror to rotate at a higher speed, thus requiring a high-speed driving motor. However, a higher speed motor may increases the production cost, and the motor rotating at high speed produces heat, vibration and noise, thus degrading the operational reliability of the apparatus provided therewith.

As another approach to improving the scanning speed of an optical scanning unit, an image head printing scheme, in which a multi-beam beamformer is utilized, has been suggested.

FIG. 2 shows an image head used in a conventional laser scanning scheme. As shown in this figure, an image head 20 has an LED array composed of a sufficient number of LEDs to cover the scanning width of a paper to be printed. In contrast to the laser scanning scheme, this image head printing scheme uses neither a polygon mirror nor an f-θ lens and forms multibeam light which allows all of the content of a line to be printed at the same time, thereby significantly enhancing the printing speed.

However, the image head printing scheme suffers from the disadvantage of having increased production cost because there is a large number of LEDs 22 in the LED array 21 and uniform images are not obtained due to low optical uniformity among LEDs 22 in the array.

### SUMMARY OF THE INVENTION

Accordingly, the present invention has been made keeping in mind the above problems occurring in the prior art, and an object of the present invention is to provide a printing apparatus using an optical modulator, which is able to form latent images having improved resolution on the surface of a photosensitive drum by dividing multibeam light according to wavelength and diffraction order through reflection and diffraction to form beams having different wavelengths and diffraction orders, and radiating the beams on respective surface sections of a photosensitive drum.

In accordance with the present invention, the above object could be accomplished by the provision of a printing apparatus using an order separation and multibeam formation based optical modulator, comprising: an illumination lens unit for converting multibeam light incident from a light source unit into linear parallel beams; a diffractive optical modulator for modulating the linear parallel beams emergent from the illumination lens unit to form diffracted multibeam light having a plurality of diffraction orders; a filter unit for separating the diffracted multibeam light according to diffraction order and for selectively passing the resulting separated beams therethrough; and a projection system in which a drum has a surface divided into two or more sections and the diffracted beams are assigned to the respective sections according to wavelength and diffraction order so as to form latent images on the surface of the drum.

### BRIEF DESCRIPTION OF THE DRAWINGS

The accompanying drawings are included to provide a further understanding of the present invention and are incorporated in and constitute a part of this specification. The drawings illustrate exemplary embodiments of the present invention and together with the description serve to explain the principles of the invention. Other objects of the present invention and many attendant advantages of the present invention will be readily appreciated as the same becomes better understood by reference to the following detailed description when considered in connection with the accompanying drawings, in which like reference numerals designate like parts throughout the figures.

FIG. 1 is a schematic view showing a conventional laser scanning scheme using a single light source and an f-θ lens;

FIG. 2 is a schematic view showing a conventional laser scanning scheme of performing laser scanning using a plurality of beams emitted from an LED array built in an image head;

FIG. 3 is a schematic view showing the structure of an order separation- and multibeam formation-based printing apparatus using a diffractive optical modulator in accordance with an embodiment of the present invention;

FIGS. 4A˜4C shows optical paths of a light beam passing through an illumination lens unit used in the printing apparatus of FIG. 3 in perspective view, plan view and side cross sectional view;

FIG. 5 is a perspective view showing a diffractive optical modulator used in the printing apparatus of FIG. 3;

FIG. 6 is a schematic view illustrating the angle of reflection of the diffractive modulator of FIG. 5;

FIG. 7 is a schematic view showing a diffracted light beam formed by the diffractive optical modulator of FIG. 5;

FIG. 8A and 8B are a plan view and a cross sectional view, respectively, showing the optical paths of light beams passing through a Fourier lens used in the printing apparatus of FIG. 3;

FIG. 9A and 9B are schematic views showing examples of filters useful in the printing apparatus of FIG. 3; and

FIG. 10 is a schematic view showing the structure of an order separation- and multibeam formation-based printing apparatus using a diffractive optical modulator, in accordance with another embodiment of the present invention.

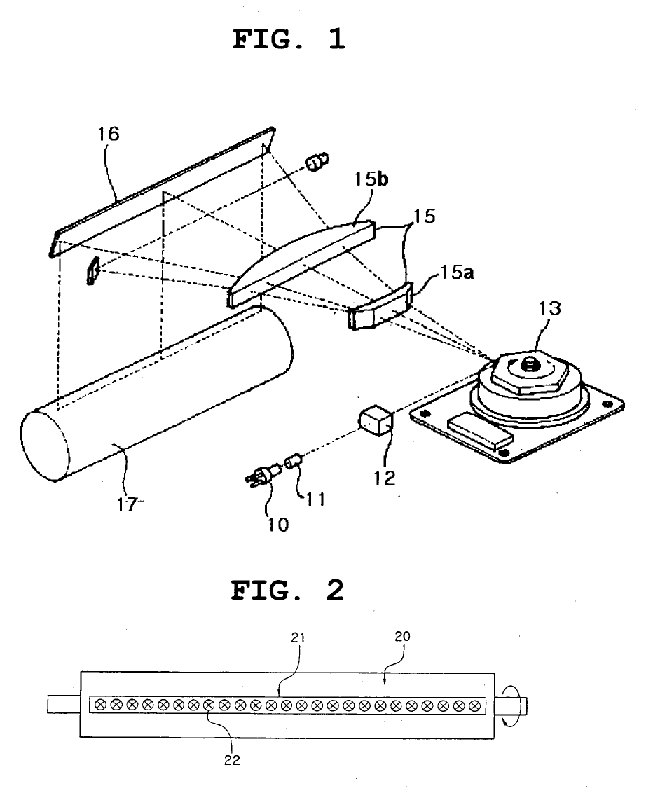

### DESCRIPTION OF THE PREFERRED EMBODIMENTS

Reference should be made to the drawings to describe the structure of an order separation- and multibeam formation-based printing apparatus using an optical modulator, in detail. A description will be given of a piezoelectric diffractive optical modulator, below, but it should be understood that the principle of the present invention is applicable to transmissive, reflective, or other diffractive optical modulators.

FIG. 3 is a diagram that shows the structure of a printing apparatus using an order separation and multibeam formation-based optical modulator, in accordance with an embodiment of the present invention.

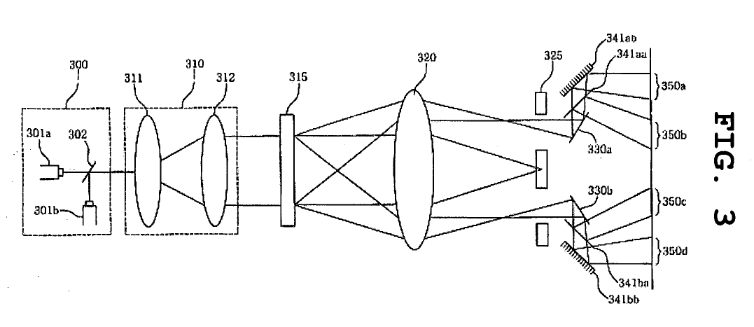

This printing apparatus using an order separation and multibeam formation-based optical modulator, as seen in FIG. 2, comprises a light source unit 300, an illumination lens 310, a diffractive optical modulator 315, a Fourier lens 320, a filter 325, reflection mirrors 330 and 340 and a drum 350.

The light source unit 300 is composed of a plurality of light sources 301a and 301b, which emit beams having wavelengths different from one another, and a dichroic mirror 302. For the preparation of the light sources 301a and 301b, semiconductor devices such as light emitting diodes (LEDs) or laser diodes (LDs) may be employed. Functioning as a filter that passes light beams having certain wavelengths therethrough but reflects light beams having different wavelengths, the dichroic mirror 32 can focus light beams emergent from the light sources 301a and 301b of different wavelengths to form multibeam light.

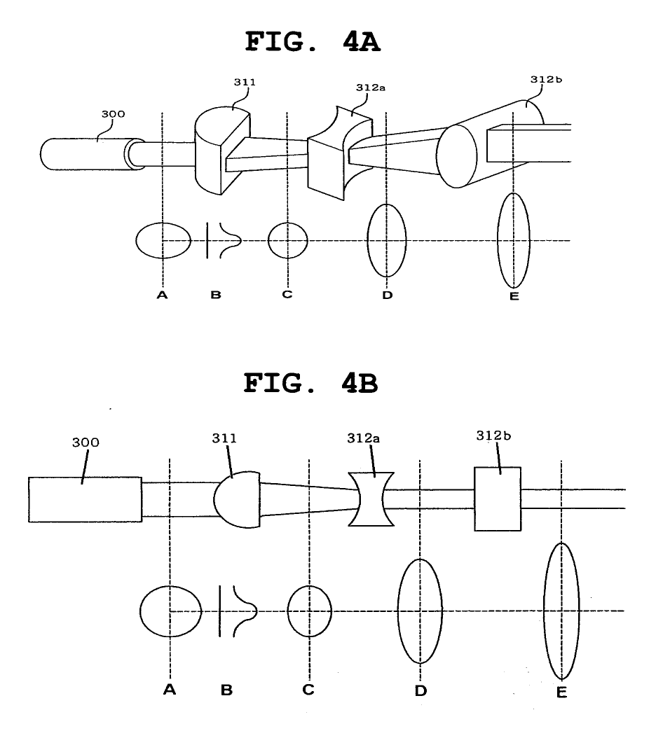

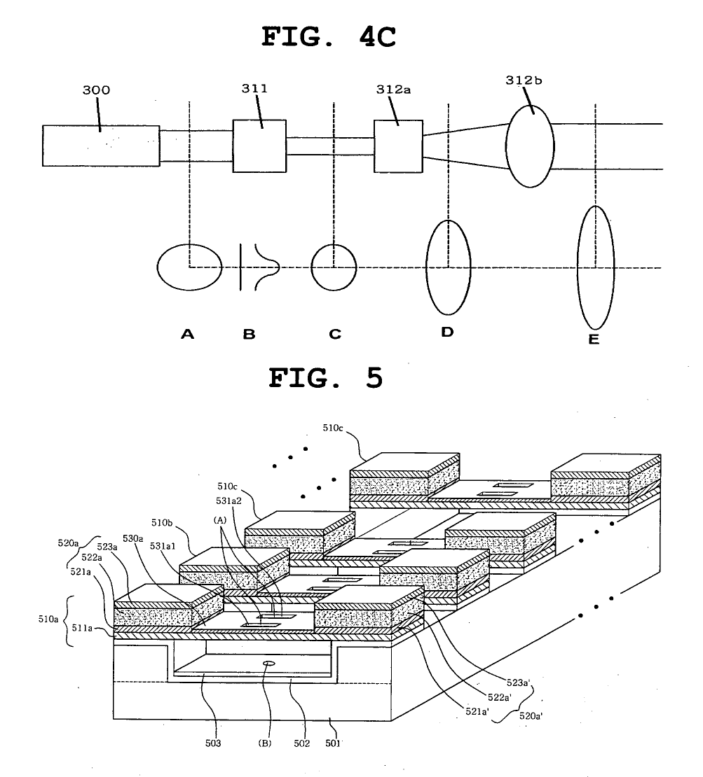

A cross section of the multibeam light emerging from the light source unit 300 is depicted in (A) of FIGS. 4A˜4C. The multibeam light emerging from the light source unit 300 has a circular cross section, while its intensity profile forms a Gaussian distribution, as seen in (B) of FIGS. 4A˜4C.

Composed of a cylinder lens 311 and a collimator lens 312, the illumination lens unit 310 converts the incident beam into linear parallel beams with an elliptical cross section as seen in (C) to (E) of FIGS. 4A˜4C. That is, through the cylinder lens 311 and the collimator lens 312, the beam emergent from the light source unit 300 is made linear in a direction parallel to the optical direction and thus incident on the diffractive optical modulator 315, aligned parallel to the optical path.

When emerging out of the cylinder lens 311, the incident linear beam is converted into a linear beam parallel to the direction of the optical path.

Before being incident on the diffractive optical modulator 315, the linear beam transmitted through the cylinder lens 311 is collimated into parallel beams by the collimator lens 312.

In an embodiment of the present invention, the collimator lens 312 may be comprised of a concave lens 312a and a convex lens 312b, as seen in FIGS. 4A˜4C.

The concave lens 312a allows the linear beam to diverge up and down and be incident on the convex lens 312b as seen in (D) of FIGS. 4A˜4C. After passing through the convex lens 312b, a parallel beam emerges, as seen in (E) of FIGS. 4A˜4C.

Thereafter, the diffractive optical modulator 315 diffracts the light incident from the illumination lens unit 310 to produce diffracted light having a plurality of orders.

In FIG. 5, an example of the diffractive optical modulator 315, having an open-hole type structure, used in the present invention is depicted. As seen in this figure, the open-hole based diffractive optical modulator comprises a base substrate 501, an insulation layer 502, a lower micromirror 503, and a plurality of elements 510a to 510n. Although being separated from the lower micromirror in this figure, the insulation layer, if reflective, may itself be used as the micromirror.

The base substrate 501 has a depression, formed in a middle portion, for providing air spaces for the elements 510a˜510n, with the insulation layer 502 formed over predetermined areas of the upper surface thereof. The lower micromirror 503 is deposited on the insulation layer 502 within the depression. On each of the opposite banks located beside the depression, an array of elements 510a˜510n is built. The base substrate 501a may be made from a single material selected from among Si, Al₂O₃, ZrO₂, quartz, SiO₂, etc., or may be divided into two parts having materials different from each other (on the basis of the dotted line represented in the figure).

The micromirror 503, deposited on the base substrate 501, functions to reflect an incident light beam for the purpose of diffraction. The lower micromirror 503 is made of metal such as Al, Pt, Cr, Ag, etc.

Because the elements have the same structure, only one of them will be described below. As seen, the element 510a looks like a ribbon and has a lower support 511a which spans the depression over a set of opposite banks, at its lowest layer, so that the element 501a is spaced apart from the depression of the base substrate 501 at a middle portion.

Piezoelectric cells 520a and 520a′ are respectively formed on opposite side portions of the lower support 511a, and contract or expand to provide the drive power of the element 510a.

As a material for the lower support 511a, Si oxides, such as SiO₂, Si nitrides, such as (Si₃N₄), and Si carbides may be used. Also, a ceramic substrate, such as Si, ZrO₂ or Al₂O₃, may be used as the lower support 511a. Optionally, the lower support 511a may be omitted.

Each of the piezoelectric cells 520a and 520a′ disposed on respective side portions of the lower support includes a lower electrode layer 521a, 521a′ and an upper electrode layer 523a and 523a′ with a piezoelectric layer 522a, 522a′ interposed therebetween. When an external electrical field is applied across the lower electrode layer 521a, 521a′ and the upper electrode layer 523a, 523a′, the piezoelectric layer 522a, 522a′ contracts and expands in response to the drive power applied, to cause motion of the lower support 511a in a direction perpendicular to its plane.

For the formation of the electrodes 521a, 521a′, 523a, 523a′, a material selected from among Pt, Ta/Pt, Ni, Au, Al, RuO2, etc. may deposited in a thickness from 0.01 to 3 μm by a dry-type method such as sputtering, evaporation, etc.

In each element, an upper micromirror 530a provided with a plurality of open holes 531a1, 531a2 is deposited on a middle portion of the lower support 511a. The open hole may have any shape. For example, it may be a rectangle, a circle, or an oval, or any other curved shape, preferably a rectangle. The lower support, if formed of a light reflecting material, need not have an upper micromirror deposited thereon if it can function as a mirror itself.

Upon passing through the open holes 531a1, 531a2 of the upper micromirror 530a, a light beam is diffracted and incident on corresponding areas of the lower micromirror 503, whereby a combination of the lower micromirror 503 and the upper micromirror 530a can form a pixel.

For instance, a portion A of the upper micromirror 530a, in which the open holes 531a1, 531a2 are formed, can form a pixel, in combination with a portion B of the lower micromirror 503.

When the distance between the upper micromirror 530a and the lower micromirror 503 is odd number multiples of λ/4, the diffractive light beam has maximum intensity.

The diffractive optical modulator 315 functions to diffract a linear light beam incident thereon and allow the diffracted light beam to be incident on the Fourier lens 320.

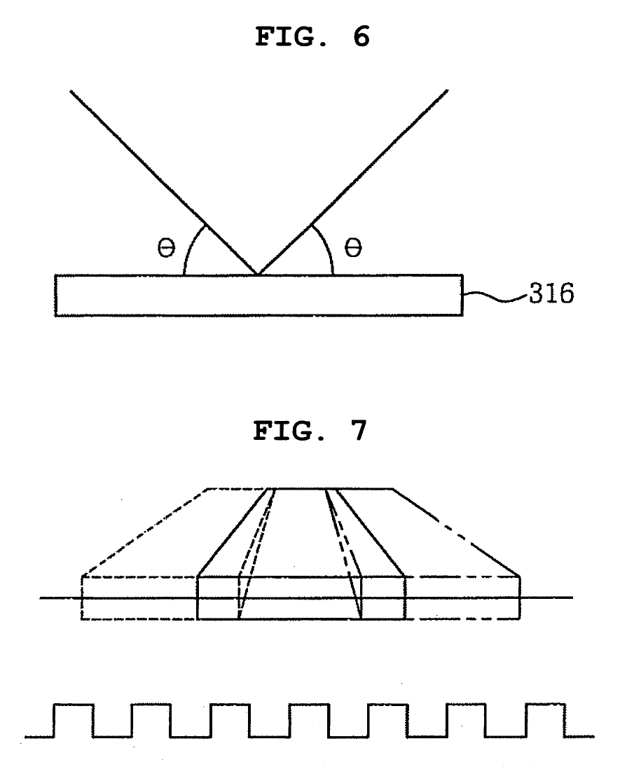

When reflected in the diffractive optical modulator, the diffracted light beam has the angle of reflection depicted in FIG. 6. As seen, the angle of incidence of the diffracted light beam is equal to the angle of reflection. That is, when the light beam is incident at an angle of θ degrees on the optical modulator 315, it is reflected at an angle of θ degrees.

Next, referring to FIG. 7, the diffracted light that is generated by the diffractive optical modulator 315 is shown. Acting as a diffraction grating, the diffractive optical modulator generates 0^{th} and ±1^{st} order diffraction beams in the periodical direction of the grating. As seen, light incident on the diffractive optical modulator is split into light beams having a plurality of diffraction orders.

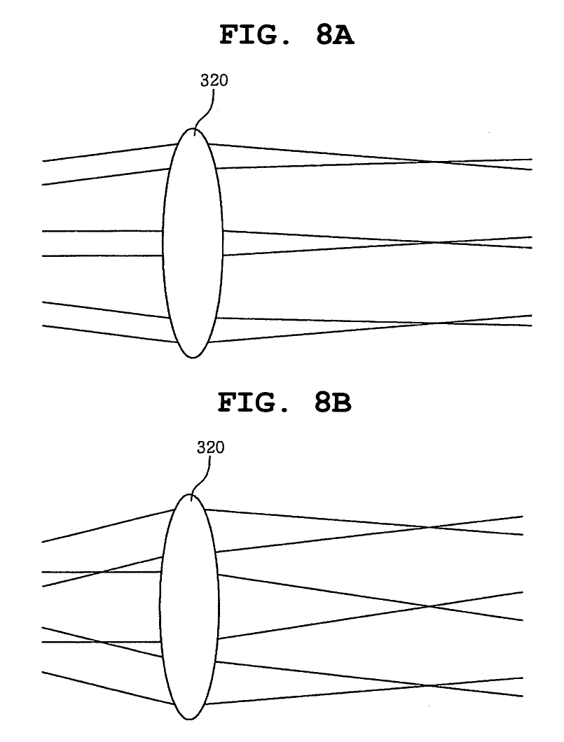

FIG. 8 shows the function of the Fourier lens 320. Using the Fourier lens 320, the diffracted light beams are aligned according to diffraction order and focused on the filter 325.

FIG. 8A is a plan view. As seen in this plan view, the diffracted light, when incident on the Fourier lens 320, is aligned and focused according to the diffraction order.

FIG. 8B is a side cross-sectional view. After passing through the Fourier lens 320, the 0^{th}-order diffraction light beam is focused on a predetermined point while the +1^{st}-order diffraction light beam and the −1^{st}-order diffraction light beam are respectively focused at positions above and below the point of focus of the 0^{th}-order diffraction light beam.

Therefore, the filter 325 performs its function by locating its slot at a position near the focused point of a desired order diffraction light beam. In detail, the 0th order diffraction light beam can be utilized when a slot capable of passing the 0th order light beam therethrough is positioned at the focused point of the 0th diffraction light beam. The same is true of the other order diffraction light beams. Accordingly, the diffracted light beams can be selectively utilized by locating the slots of the filter at appropriate positions.

Particularly in the present invention, the diffractive optical modulator 315 modulates the light beams incident thereon in a time divisional manner. The optical modulator perform modulation functions on the optical information that is incident on a first drum surface 350a during a first predetermined time period, on the optical information that is incident on a second drum surface 350b during a second predetermined time period, on the optical information that is incident on a third drum surface 350c during a third predetermined time period, and on the optical information that is incident on a fourth drum surface during a fourth predetermined time period. Accordingly, the filter 325 passes only +1^{st}-order diffraction light beams having a first wavelength therethrough and thus allows a modulated diffracted light beam to be incident on the first drum surface 350a during the first time period. Next, the filter 325 allows the passage of only +1^{st}-order diffraction light beams having a second wavelength to be incident on the second drum surface 350b during the second time period. Likewise, the filter 325 passes only −1^{st}-order diffraction light beams having the second wavelength so as to allow a modulated light beam to be incident on the third drum surface 350c during the third time period, and then, −1^{st}-order light beams having the first wavelength are passed and then incident on the fourth drum surface 350d during the next time period. With this structure, the diffractive optical modulator 315 can obtain four times higher resolution than can a conventional optical modulator having the same number of pixels.

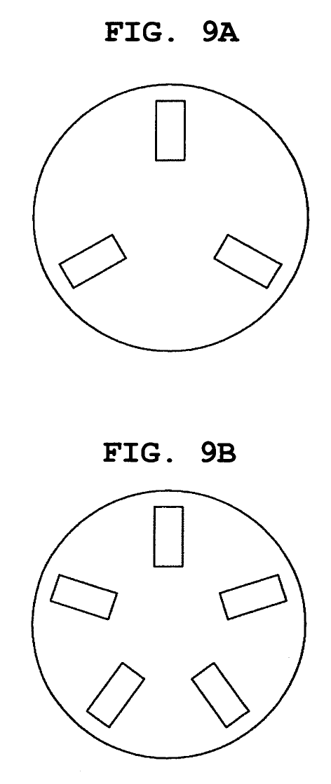

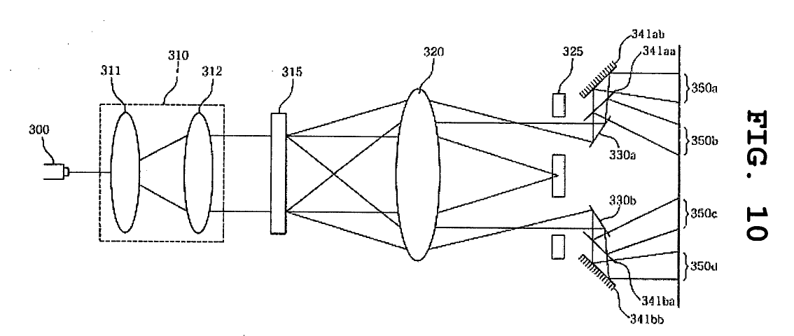

In response to the order-dependant, time-divisional modulation of the diffractive optical modulator 315, the filter 325 must have a filtering function. In detail, when +1^{st}-order diffracted light having the first wavelength is passed, the filter 325 must block +1^{st}-order diffracted light beams having the second wavelength and −1^{st}-order diffracted light beams having the first and second wavelengths from passing therethrough. The passage of the +1^{st}-order diffracted light beams requires that the filter not allow the passage of other diffracted light beams, including +1^{st}-order diffracted light beams having the first wavelength and −1^{st}-order diffracted light beams having the first and second wavelengths. Likewise, while passing −1^{st}-order diffracted light beams having the first wavelength therethrough, the filter block the passage of other diffracted light beams, including +1^{st}-order diffracted light beams and −1^{st}-order. diffracted light beams having the second wavelength. Also, the passage of −1^{st}-order diffracted light beams of the second wavelength excludes the passage of the other diffracted light beams, including the +1^{st}-order diffracted light beams and the −1^{st}-order diffracted light beam having the first wavelength. In this regard, the filter 325 may be a rotary filter in which slots are designed to be positioned on different axes that cross each other, as depicted in FIGS. 9A and 9B. Of course, dichroic filters may be used for the selective passage of the appropriate diffracted light beams. If N is an integer, the rotary filter may have 2N+1 slots as seen in FIGS. 9A and 9B.

Turning to FIG. 3, a combination of a reflection mirror 330a, a dichroic mirror 340aa, and a reflection mirror 340ab guides the +1^{st}-order diffracted light beams having the first wavelength onto a first surface area 350a of the drum. Through the reflection mirror 330a and the dichroic mirror 340aa, the +1^{st}-order diffracted light beams having the second wavelength are reflected onto a second surface area 350b of the drum while a combination of a reflection mirror 330b and a dichroic mirror 340ba leads the −1^{st}-order diffracted light beams having the second wavelength onto a third surface area of the drum. Along a combination of a reflection mirror 330b, a dichroic mirror 340ba and a reflection mirror 340bb, the 1^{st}-order diffracted light beams having the first wavelength reach a fourth surface area 350d of the drum.

FIG. 10 depicts the structure of a printing apparatus of an order separation and multibeam formation-based optical modulator, in accordance with an embodiment of the present invention.

The difference between the printing apparatuses of FIGS. 10 and 3 is in the light sources used: the printing apparatus of FIG. 3 uses monochromic light sources while the printing apparatus of FIG. 10 uses a polychromic light source.

As described hereinbefore, the printing apparatus using an order-separation and multibeam formation-based diffractive optical modulator in accordance with the present invention is able to form images on a large screen using the lowest possible number of actuating cells, with the concomitant advantage of obtaining high resolution at a low cost.

Although the preferred embodiments of the present invention have been disclosed for illustrative purpose, those skilled in the art will appreciate that various modifications, additions and substitutions are possible, without departing from the scope and spirit of the invention as disclosed in the accompanying claims.

What is claimed is:

1. An order separation and multibeam formation-based printing apparatus using an optical modulator, comprising:
an illumination lens unit for converting multibeam light incident from a light source unit into linear parallel beams;
a diffractive optical modulator for modulating the linear parallel beams emergent from the illumination lens unit to form diffracted multibeam light having a plurality of diffraction orders;
a filter unit for separating the diffracted multibeam light according to diffraction order and for selectively passing the resulting separated beams therethrough; and
a projection system in which a drum has a surface divided into two or more sections and the diffracted beams are assigned to respective sections according to wavelength and diffraction order so as to form latent images on the surface of the drum.

2. The order separation and multibeam formation-based printing apparatus as set forth in claim 1, wherein the light source unit is a multibeam light source.

3. The order separation and multibeam formation-based printing apparatus as set forth in claim 1, wherein the light source unit comprises:
a plurality of light sources emitting light beams having wavelengths different from one another; and
a concentrating entity for concentrating the light beams having different wavelengths, emitted from the light sources, to be emergent as concentrated light beams.

4. The order separation and multibeam formation-based printing apparatus as set forth in claim 1, wherein the illumination lens unit comprises:
a cylinder lens for linearizing the light emitted from the light source unit; and
a collimator lens for parallelizing the light linearized by the cylinder lens.

5. The order separation and multibeam formation-based printing apparatus as set forth in claim 1, wherein the filter unit comprises:
a Fourier lens for aligning and focusing the diffracted light beams according to diffraction order; and
a filter for selectively passing the diffracted light beams according to wavelength and diffraction order.

6. The order separation and multibeam formation-based printing apparatus as set forth in claim 5, wherein the filter is a rotary circular plate in which 2N+1 slits are formed, where N is an integer.
